(19) United States
(12) Patent Application Publication
(10) Pub. No.: US 2004/0114371 A1
(43) Pub. Date: Jun. 17, 2004

(54) Luminaire comprising an elongate light source and a back reflector

(76) Inventors: Michael C. Lea, Berkshire (GB); John C. Wright, Bucks (GB); Andrew M. Hicks, Berkshire (DE)

Correspondence Address: 3M INNOVATIVE PROPERTIES COMPANY, P.O. BOX 33427, ST. PAUL, MN, 55133-3427, US

(21) Appl. No.: 10/433,302

(22) PCT Filed: Dec. 6, 2001
(86) PCT No.: PCT/US01/46583

(30) Foreign Application Priority Data
Dec. 11, 2000 (GB) 0030150.7

(51) Int. Cl. F21V 7/00

(52) U.S. Cl. 362/297

(57) ABSTRACT

A luminaire (1) comprises a reflector (3) that defines an elongate concave cavity in which an elongate light source (2), for example a fluorescent tube, is located in spaced relationship to the reflector whereby the latter surrounds the light source on its rearward side to reflect light from the source and cause it to be emitted from the cavity in a generally-forwards direction. To enable the distribution of light from the luminaire (1) to be tailored to meet the requirements of the situation in which the luminaire is to be used, the reflector (3) is provided, on opposite sides of the cavity, with a respective prismatic structure (6) upstanding from its inner surface to intercept and deviate light that is emitted, in the generally-forwards direction, from the space in the cavity between the light source (2) and the reflector (3).

The present invention relates to luminaires of the type comprising an elongate light source and a back reflector. The invention is especially, but not exclusively, applicable to luminaries employing fluorescent tubes as light sources.

Elongate light sources in the form of fluorescent tubes are widely used in luminaires for space lighting, both indoors and outdoors. They also have many other uses, for example in shelf lighting and in display lighting, including not only commercial and emergency signs but also electronic displays.

The distribution of light required from a luminaire depends on the use for which the luminaire is intended. For example, in the case of ceiling-mounted luminaires employing fluorescent tubes for general space lighting, a light output having a wide angle transverse distribution of the so-called “batwing” type is often preferred because that enables a relatively uniform level of illumination at floor level to be achieved even when the luminaires are comparatively widely spaced. If the space to be illuminated is one in which computer display screens are used, the “batwing” distribution preferably exhibits a cut-off at about 60° on either side of the downward vertical to reduce the amount of glare from the display screens experienced by the users. On the other hand, when a luminaire employing a fluorescent tube is used for edge illumination of a light guide, for example to provide a backlight system for a display, the light output of the luminaire should have a narrow transverse distribution so that as much light as possible is injected into the guide.

A fluorescent tube will normally emit light generally uniformly in all directions around its axis and, in a luminaire, it is often provided with a back reflector for re-directing rearwardly-emitted light in a forwards direction. Spaced back reflectors are widely used with fluorescent tubes for space lighting, and are also frequently used with fluorescent tubes in backlights for electronic displays, and they can result in luminaires that are very efficient in their use of energy. The back reflectors are, however, often very bulky in comparison with the light sources, and not always suitable for use in confined spaces. Moreover, when the luminaires are used for space lighting, front diffusers are often also required to provide a uniform level of illumination at floor level and add further to the bulkiness of the construction.

Examples of luminaires comprising a linear light source provided with a spaced back reflector are described in U.S. Pat. No. 4,642,741, U.S. Pat. No. 4,514,793 and U.S. Pat. No. 3,654,471. In the arrangement described in U.S. Pat. No. 4,642,741, the back reflector can be wrapped around the linear light source for shipment and handling.

As an alternative to luminaires comprising fluorescent tubes with spaced back reflectors, so-called “aperture lamps” have been developed. In this type of elongate light source, a reflective material closely surrounds (or is integral with) part of the circumference of the fluorescent tube leaving an elongate aperture through which the light (including light reflected by the reflective material) can emerge. The reflective material can be a sheet material or a coating applied directly to the inside or the outside of the fluorescent tube, or applied to the inside or outside of a protective sheath that completely surrounds the tube. Depending on the reflective material employed and the size of the elongate aperture that is formed, the aperture can exhibit high levels of surface luminance but does not always provide a controlled light distribution.

Examples of aperture lamps are described in U.S. Pat. No. 3,115,309, U.S. Pat. No. 4,186,431, U.S. Pat. No. 4,991,070, U.S. Pat. No. 5,036,436, U.S. Pat. No. 5,510,965, WO 94/22160, and WO 99/60303. In the arrangement described in U.S. Pat. No. 5,510,965, a printed film is used as the reflector, and the printing pattern is selected to modify the output of the light source in a required manner.

In some cases, back reflectors have been used that engage closely around a lighting tube. Examples of that type of arrangement are described in U.S. Pat. No. 2,078,370, U.S. Pat. No. 2,595,275, U.S. Pat. No. 3,140,055, and DE-A-195 28 962. In some of those examples, the reflectors are provided with portions that extend away from the lighting tube (see U.S. Pat. No. 2,078,370, U.S. Pat. No. 2,595,275 and U.S. Pat. No. 3,140,055).

Although a lighting tube with a spaced back reflector requires more space, it will generally be more energy-efficient than a comparable aperture lamp, because light will undergo fewer reflections before being emitted in the forwards direction so that the amount of light lost on reflection is reduced.

U.S. Pat. No. 4,933,821 and U.S. Pat. No. 5,414,604 describe luminaires comprising spaced back reflectors that are shaped to ensure that some of the light from a fluorescent tube leaves the luminaire at a sharp angle to the remainder of the light. In the luminaire described in U.S. Pat. No. 4,933,021 that is achieved by shaping the edge of the reflector. In U.S. Pat. No. 4,418,378, the output of a fluorescent tube used in a light box is modified by providing the tube with an apertured sleeve with cut-away ends.

The problem with which the present invention is concerned is that of providing, for an elongate light source in a luminaire, a reflector that is comparatively compact and will not only re-direct light in a required direction but will also enable the distribution of the light from a luminaire to be tailored to meet the requirements of particular situations in which the luminaire is to be used.

The present invention provides a luminaire comprising a reflector that defines an elongate concave cavity in which an elongate light source is located in spaced relationship to the reflector whereby the latter surrounds the light source on its rearward side to reflect light from the source and cause it to be emitted from the cavity in a generally-forwards direction; the reflector being provided with a prismatic structure upstanding from its inner surface to intercept and deviate light that is emitted, in the generally-forwards direction, from the space in the cavity between the light source and the reflector.

The present invention also provides a luminaire comprising a reflector that defines an elongate concave cavity in which an elongate light source is located in spaced relationship to the reflector whereby the latter surrounds the light source on its rearward side to reflect light from the source and cause it to be emitted from the cavity in a generally-forwards direction; the reflector being provided, on opposite sides of the cavity, with a respective prismatic structure upstanding from its inner surface to intercept and deviate light that is emitted, in the generally-forwards direction, from the space in the cavity between the light source and the reflector.

The elongate light source of a luminaire in accordance with the invention should be one that will not completely absorb light that is returned to it by the reflector and will preferably absorb substantially none of that light. A suitable light source is a fluorescent tube.

The term “light” as used herein refers to electromagnetic radiation in the ultraviolet, visible and/or infrared regions of the electromagnetic spectrum.

The term “prismatic structure” as used herein normally refers to a structure whose two ends are similar, equal and parallel rectilinear figures, and whose sides are parallelograms. In its simplest form, a prismatic structure has a triangular cross-section. However, as used herein, the term extends to structures having cross-sections with more than three sides and also to the limiting case in which the structure has a cross-section with a multiplicity of sides to the extent that at least some of those sides form a curve.

By way of example only, embodiments of the invention will be described with reference to the accompanying drawings, in which:

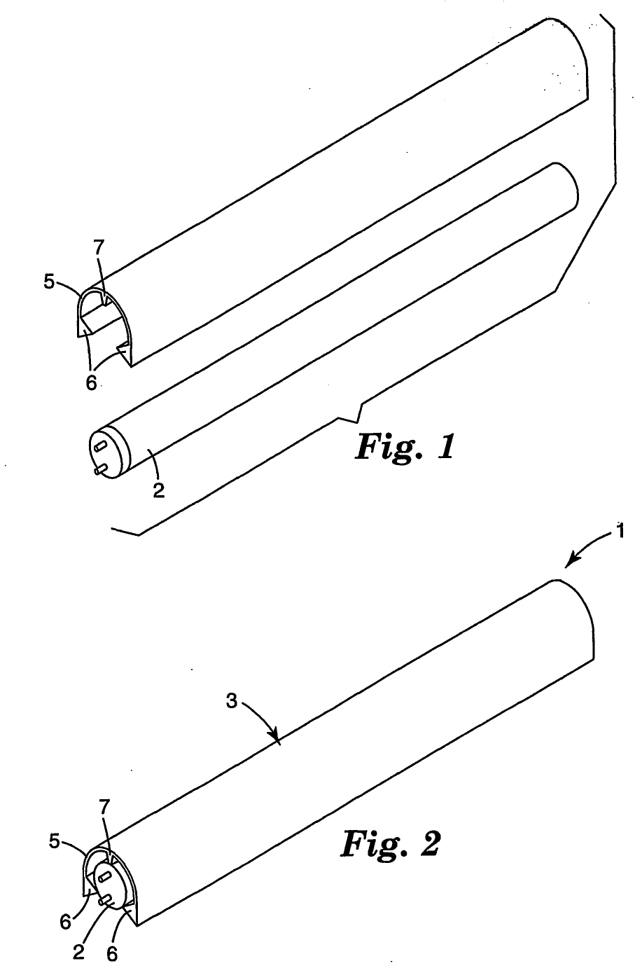

FIG. 1 is an exploded perspective view of a luminaire in accordance with the present invention;

FIG. 2 is a perspective view of the luminaire of FIG. 1, in an assembled condition;

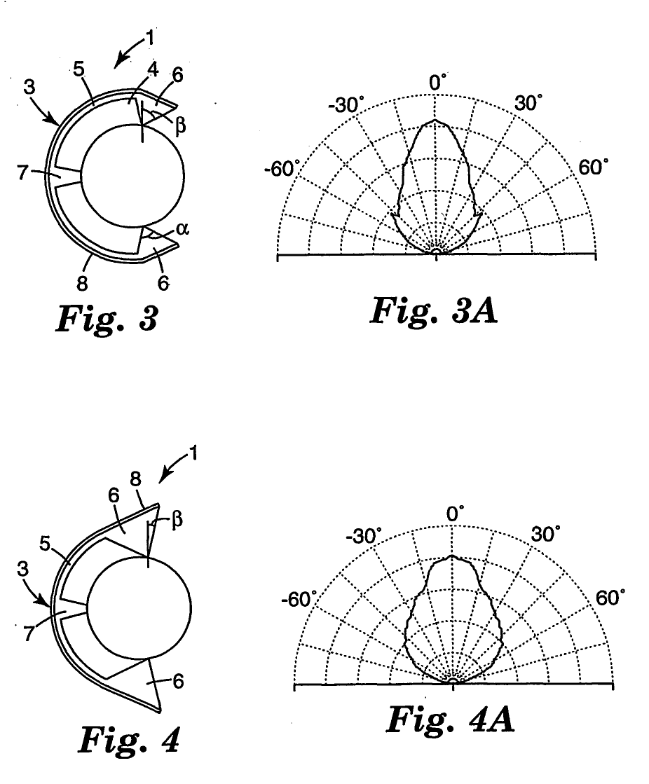

FIG. 3 shows a traverse cross-section through the luminaire of FIG. 2;

FIG. 3A illustrates the output light distribution of the luminaire in the plane of FIG. 3;

FIGS. 4, 5, 6 and 7 show transverse cross-sections through respective luminaires in accordance with the invention;

FIGS. 4A, 5A and 6A illustrate the output light distributions of the luminaires of FIGS. 4, 5 and 6 respectively in the planes of those Figures; and

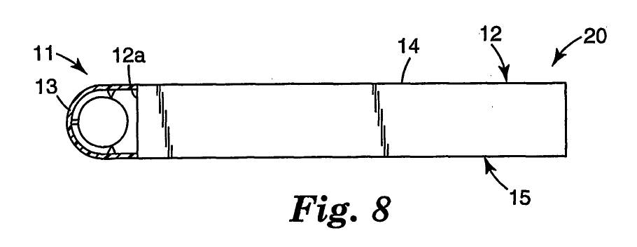

FIG. 8 is a diagrammatic illustration of a backlighting system incorporating a luminaire in accordance with the invention.

The luminaire 1, shown in an exploded condition in FIG. 1 and in an assembled condition in FIG. 2, comprises a linear fluorescent tube and a reflector 3. The reflector 3 is of elongate form and, as shown in FIG. 3, has a generally-concave transverse cross-section that defines a cavity 4 in which the light source 2 is located so that it is partially surrounded, on one side, by the reflector. The reflector 3 forms the rear of the luminaire which, in use, is intended to emit light in a forwards direction, out of the cavity 4 (that is, away from the reflector).

The reflector 3 comprises an elongate shell 5 with a transverse cross-section that is approximately semi-circular, and three upstanding longitudinally-extending ribs 6, 7 on its inner surface. Two of the upstanding ribs, indicated by the reference 6, are located at the longitudinal edges of the shell 5, and the third upstanding rib 7 is located at the centre. The reflector 3, comprising the shell 5 and the ribs 6, 7, is formed from an optically-transparent (preferably polymeric) material and is preferably a moulded or extruded component. A suitable material for the reflector 3 is polycarbonate but it could, alternatively, be formed from an acrylic material. The ribs 6, 7 contact the envelope of the fluorescent tube 2 and serve to space the shell 5 from the latter and, in the case of the ribs 6, to modify the distribution of the light leaving the luminaire 1 as will be described in greater detail later. A highly-efficient specularly-reflecting layer 8 is formed on the outer surface of the shell 5 (including, as shown, the edge portions opposite the bases of the ribs 6) to reflect light passing through the shell from the light source 2.

The reflector 3 may be mounted on, or form a part of, a fitting for receiving the fluorescent tube 2. Alternatively, it may be mounted directly on the envelope of the tube 2, in a manner that permits it to be removed and, possibly, adjusted relative to the tube as required. In a preferred arrangement, the reflector 3 extends around the fluorescent tube 2 to an extent that enables it to be retained on the tube solely by the action of the ribs 6, it being necessary only to provide some means for securing the reflector relative to the tube in the desired circumferential location. In that case, the shell 5 of the reflector 3 must be sufficiently flexible to permit insertion and removal of the tube 2 when required. Various other arrangements for mounting a reflector directly on the envelope of a fluorescent lamp are known, and examples are described in U.S. Pat. Nos. 4,514,793 and 2,595,275. Alternatively, the reflector 3 may be mounted using the same arrangement as the reflector available under the trade designation “Clip-On Reflector” available from Minnesota Mining and Manufacturing Company of St. Paul, Minn., USA.

The luminaire 1 functions generally as follows. The fluorescent tube 2 will emit light generally uniformly in all directions around its longitudinal axis. Light that is emitted in the rearwards direction, i.e. towards the reflector 3, will pass through the shell 5 and be reflected by the layer 8 back towards the fluorescent tube 2, where it may be reflected again and returned to the layer 8. Light may, in fact, undergo multiple reflections in the cavity 4, in the space between the fluorescent tube 2 and the shell 5, before it is finally able to leave the cavity 4 (travelling in the forwards direction) through either the tube 2 or one of the ribs 6. As so far described, the reflector 3 functions in a conventional manner.

To reduce the amount of light lost on reflection at the layer 8, the latter should have a reflectivity of at least 90%, preferably at least 98%, facing into the cavity 4. The layer 8 may comprise a reflective film that is laminated to the outer surface of the shell 5, in which case a preferred reflective film is a multi-layer optical film of the type described in U.S. Pat. No. 5,882,774 and WO 97/01774. A suitable alternative film is available, under the trade designation “Miro”, from Alanod of Ennepetal, Germany. As an alternative to the use of a reflective film, the layer 8 could be a vapour-deposited layer. In some cases, the layer 8 may be primarily a diffusely-reflecting material although strips of specularly-reflecting material would be required opposite the bases of the ribs 6.

In a modification of the arrangement shown in FIG. 3, the reflective layer 8 is transferred to the inner surface of the shell 5, although strips of specularly-reflective material are retained on the outer surface opposite the bases of the ribs 6.

Each of the ribs 6 is in the form of a prism having a triangular cross-section, the base of the prism being a continuation of the outer surface of the shell 5 of the reflector 3 and the apex of the prism being adjacent the envelope of the fluorescent tube 2. The two prisms 6 have identical cross-sections in the form of an isosceles triangle and are positioned and oriented symmetrically relative to the tube 2. Light that passes through one of the prisms 6 as it leaves the cavity 4 will be deviated by the prism and, through an appropriate orientation of the prism and selection of the prism angle, it is possible to control the direction in which that light will leave the luminaire. It is further possible to adjust the amount of light that passes through the prisms 6 by altering the extent to which the reflector 3 wraps around the fluorescent tube 2.

In the case of the reflector illustrated in FIG. 3, the extent of the reflector 3 (measured as the distance between the apexes of the prisms 6) is such that the reflector wraps around 55% of the circumference of the tube 2. The prisms 6 have a prism angle α of 76° and each is oriented so that the outer face of the prism is at an angle β of 68° to the plane containing the prism apexes with the result that the prism apexes are directed into the cavity 4. FIG. 3A illustrates the effect of the reflector 3 on the angular distribution of light from a luminaire of this construction, in the plane of FIG. 3 (i.e. transverse to the length of the tube 2). FIG. 3A shows that, in this plane, the light has an intensity peak in the forwards direction (0° in FIG. 3A) and declines to zero on each side of the forwards direction more rapidly than would the light from a Lambertian source. In the orthogonal plane (i.e. along the length of the tube 2), the light also has an intensity peak in the forwards direction but the effect of the reflector 3 is less apparent.

FIG. 4 is similar to FIG. 3 and illustrates a luminaire in which the prisms 6 are oriented so that the outer face of each prism is at an angle β of 8° to the plane containing the prism apexes, with the result that the apex of each prism is directed out of the cavity 4. FIG. 4A is similar to FIG. 3A and illustrates the effect of the reflector 3 on the angular distribution, in the plane of FIG. 4, of the light from a luminaire of this construction. It will be seen that, in this plane, the light again has an intensity peak in the forwards direction (0° in FIG. 4). In the orthogonal plane (i.e. along the length of the tube 2), the light also has an intensity peak in the forwards direction but the effect of the reflector 3 is less apparent.

Luminaires of the type shown in FIGS. 3 and 4, which provide a beam of light with an intensity peak in the forwards direction, are particularly suitable for edge illumination of light guides because they will enable a comparatively high level of light to be injected into the guide thereby enabling the efficiency of the system to be increased. The light guides can have various uses, for example, as electronic displays or edge-lit signs or may, themselves, also function as luminaires. Luminaires of the type shown in FIGS. 3 and 4 are also suitable for use in “wall-washing” lighting systems for illuminating surfaces (e.g. sign faces) and for illuminating merchandise in retail locations. In addition, due to their compact construction, they are particularly suitable for installation above the aisles between storage racks in warehouses to illuminate the racks effectively without hindering the mobility of forklift trucks.

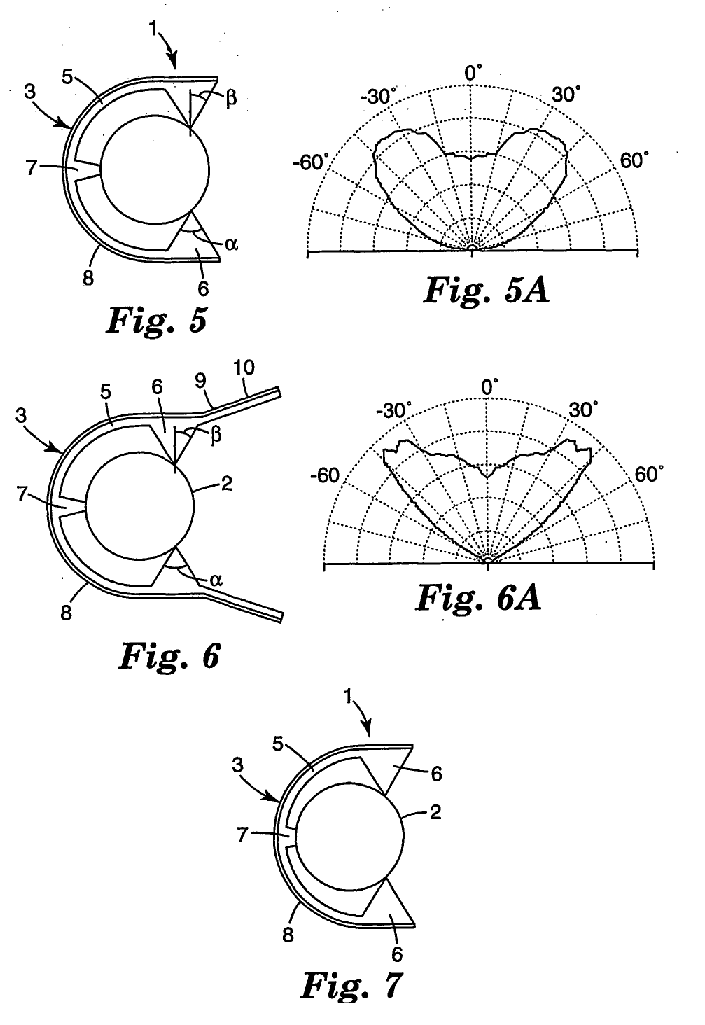

FIG. 5 is a similar view to those of FIGS. 3 and 4 but illustrates a luminaire that will provide a completely different light distribution. In this case, the extent of the reflector 3 (measured as the distance between the apexes of the prisms 6) is such that the reflector wraps around 70% of the circumference of the fluorescent tube 2. In addition, although the prisms 6 still have an apex angle α of 76° as in FIGS. 3 and 4, they are oriented so that the outer face of each prism is at an angle β of 38° to the plane containing the prism apexes. FIG. 5A illustrates the effect of the reflector 3 on the angular distribution, in the plane of FIG. 5, of the light from a luminaire of this construction. The distribution has a so-called “batwing” form, in which the light intensity has two peaks, one on each side of the forwards direction (in this case, at an angle of about 40°) and then declines to zero following a Lambertian distribution as the angle widens. In the orthogonal plane (i.e. along the length of the tube 2), the effect of the reflector 3 on the angular distribution of the light is less apparent.

FIG. 6 illustrates a modification of the construction shown in FIG. 5. The principal modification comprises continuing the reflector 3 beyond the prisms 6 to form similar outwardly-inclined extensions 9 along each edge of the curved shell 5 of the reflector. A highly-efficient specularly-reflecting layer 10, similar to the layer 8, is formed on the outer surface of each extension 9. The extensions 9 function to intercept light that would otherwise leave the luminaire 1 at a comparatively wide angle (including, in each case, some light from the prism 6 on the other side of the reflector), and cause it to be emitted in a more forwards direction. FIG. 6A illustrates the angular distribution, in the plane of FIG. 6, of the light from a luminaire of this construction. The distribution still has the “batwing” form, but the light intensity in the two peaks is increased and declines to zero very rapidly at about 60° from the forwards direction on both sides.

Luminaires of the type shown in FIG. 5, providing a wideangle “batwing” distribution, are particularly suitable for general space lighting applications. It is already known, when a plurality of ceiling-mounted luminaires is used to illuminate a floor space, that luminaires providing a “batwing” distribution are most efficient in that they can be spaced more widely apart without compromising the uniformity of the illumination provided. Luminaires of the type shown in FIG. 6 are preferred for lighting spaces, such as offices, in which computer display screens are used. In that case, because the light emitted by each luminaire is contained within an angle of about 60° around the downward vertical, the glare from the display screens will be much less troublesome to the users. It will be appreciated that, for ceiling mounting, the luminaires of FIGS. 5A and 6A would be oriented so that the emitted light is directed downwards towards the floor area of the space to be illuminated.

In the luminaire constructions illustrated in FIGS. 3 to 6, the orientation of the prisms 6, the prism angle and the extent of the reflector 3 can all be altered to modify the distribution of the emitted light. Of these three factors, it has been found that the orientation of the prisms 6 has the greatest effect on the light distribution. Increasing the extent of the reflector 3 (measured between the apexes of the prisms 6), and hence the degree to which the light source 2 is surrounded, will reduce the efficiency of the luminaire since less light will be emitted but will also reduce the amount of light that is emitted in an uncontrolled manner. For a luminaire with a “batwing” light distribution as in FIGS. 5A and 6A, for example, the reflector 3 (measured between the apexes of the prisms 6) preferably surrounds about 75% of the circumference of the light source 2 although anything between 55% and 85% is satisfactory. For a luminaire with a narrow light distribution as in FIGS. 3A and 4A, on the other hand, a smaller proportion of the light source 2 would normally be surrounded by the reflector 3. In all cases, if the extent to which the reflector surrounds the light source is changed, consideration may need to be given to the mechanism used for maintaining the position of the reflector relative to the light source.

One preferred construction for providing a batwing light distribution, which is of the type shown in FIG. 6, uses a fluorescent tube 2 having a diameter of 25 mm and the distance between the apexes of the two prisms 6 of the reflector 3 is sufficient to surround about 75% of the circumference of the tube. The length of the prism sides, between the base and the apex, is 10 mm; the prism apex angle α is 74°; and the prisms are oriented so that the outer face of each prism is at an angle β of 40° to the plane containing the prism apexes. The extensions 9 have a width of 20 mm and are inclined outwards at an angle of 100° to the plane containing the apexes of the prisms 6.

As already indicated above, the reflectors 3 of the luminaires of FIGS. 3 to 6 have a controlling effect on the distribution of light in planes transverse to the length of the fluorescent tubes 2. If additional control of the light output of any one of those luminaires is required in the orthogonal plane, this can be achieved by, for example, providing louvres on the forward side of the tube 2 arranged to run across the tube.

The luminaires of FIGS. 3 to 6 can be provided with any appropriate additional features known to be suitable for use with fluorescent tubes. For example, when the reflecting layer 8 is provided by a polymeric film, a loaded polymer material may be provided as described in EP-A-0 811 305 behind the polymeric reflecting film to assist in starting and regulating the fluorescent tube.

From the above description of FIGS. 3 to 6, it will be understood that the rib 7 at the rear of the fluorescent tube 2 serves only to maintain the space between the tube and the reflector shell 5. It does not contribute to the distribution of the light from the luminaire, and could be omitted if some alternative mechanism were provided for maintaining the space between the light source and the reflector.

A particular practical advantage of the luminaire constructions illustrated in FIGS. 3 to 6 is that the space between the fluorescent tube 2 and the back reflector 3 is closed, along the length of the tube, by the prisms 6 and will consequently remain much cleaner than in a conventional arrangement. When the luminaire is used for space lighting, only the outer surfaces of the tube 2 and the prisms 6 will normally require cleaning.

Although the prismatic ribs 6 of the reflectors 3 of FIGS. 3 to 6 all have cross-sections in the form of isosceles triangles, other forms of prisms could be employed to vary the distribution of the light from the luminaire. The modifications that may be made to the prisms 6 include, for example, the provision of rounded sides, microstructured surfaces, and an asymmetric cross-section. The prisms 6 of any one reflector need not have the same shape and, depending on the light distribution required, one of the prisms may be omitted.

It is also possible to alter the relative positions of the fluorescent tube 2 and the reflector 3 so that they are no longer concentric. FIG. 7, for example, shows a luminaire with a reflector 3 similar to that of FIG. 5 except that the rib 7 is shortened so that the space between the reflector and the tube at the rear of the latter is decreased. Generally, however, a wider space between the tube 2 and the reflector 3 is preferred because light will then undergo fewer reflections before emerging from the luminaire cavity 4.

The shape of the back reflector 3 can also be modified from the generally semi-circular form shown in FIGS. 3 to 6. The reflector 3 may, for example, have a parabolic form or comprise flat surfaces. Moreover, although it is preferable for the ribs 6, 7 to be formed in one piece with the reflector shell 5, that is also not essential. The shell 5 could, for example, be formed in metal (which may, in itself, be sufficiently reflective), with the ribs 6, 7 being attached to it. In such a construction, the prismatic ribs 6 would, of course, be formed from an optically-transparent material.

Although the luminaries of FIGS. 1 to 7 utilise fluorescent tubes as the light sources, they could use any alternative form of elongate light source provided that this does not completely absorb light that is returned to it by the reflector 3. Preferably, the light source absorbs none, or substantially none, of the light that is returned to it by the reflector 3. Suitable alternative light sources include large diameter optical fibres and light guides.

FIG. 8 is a cross-sectional schematic view illustrating a backlight system 20 that includes a luminaire 11 in accordance with the invention, and a solid light guide 12. The light guide 12 is shown as having a rectangular cross-section, with the elongated luminaire positioned along one edge 12A. The use of a rectangular light guide is not essential, however, and a light guide of any other suitable shape could be used. The reflector 13 of the luminaire is selected so that the output of the luminaire is a narrow, forwardly-directed beam as illustrated in FIGS. 3A and 4A, thereby ensuring that as much of the light as possible will enter the light guide 12 through the adjacent edge 12A.

The light guide 12, which may be solid or hollow, has a front surface 14 and a back surface 15. When the backlight system is in use, a component such as a polarizer, diffuser, liquid crystal display panel, graphics film or print may be placed above the front surface 14. That component is not shown in FIG. 7 but is well known and will not be described in greater detail here. The light guide 12 further includes some form of light extraction mechanism to direct light from within the guide out through the front surface 14. Examples of known extraction mechanisms include diffusing dots on, or channels in, the back surface 15 of the guide.

A particularly advantageous feature of luminaires constructed as illustrated in FIGS. 3 to 7 is that they can be very compact in comparison with conventional luminaires employing fluorescent tubes, but will nevertheless provide effective illumination in a wide variety of locations. Luminaires that require less space offer greater design freedom in many areas including, for example, building construction, interior design and electronic displays.

1. A luminaire comprising a reflector that defines an elongate concave cavity in which an elongate light source is located in spaced relationship to the reflector whereby the latter surrounds the light source on its rearward side to reflect light from the source and cause it to be emitted from the cavity in a generally-forwards direction; the reflector being provided with a prismatic structure upstanding from its inner surface to intercept and deviate light that is emitted, in the generally-forwards direction, from the space in the cavity between the light source and the reflector.

2. A luminaire comprising a reflector that defines an elongate concave cavity in which an elongate light source is located in spaced relationship to the reflector whereby the latter surrounds the light source on its rearward side to reflect light from the source and cause it to be emitted from the cavity in a generally-forwards direction; the reflector being provided, on opposite sides of the cavity, with a respective prismatic structure upstanding from its inner surface to intercept and deviate light that is emitted, in the generally-forwards direction, from the space in the cavity between the light source and the reflector.

3. A luminaire as claimed in claim 2, in which the reflector further comprises, on each side of the cavity and on the forward side of the respective prismatic structure, an additional reflecting surface positioned to intercept light emitted by the prismatic structure on the opposite side of the cavity.

4. A luminaire as claimed in any one of the preceding claims, in which the/each prismatic structure extends along the length of the reflector.

5. A luminaire as claimed in any one of the preceding claims, in which the/each prismatic structure has a generally triangular cross-section and is oriented with the apex of the prismatic structure remote from the reflector surface.

6. A luminaire as claimed in claim 5, in which the/each prismatic structure is oriented with the apex of the structure directed into, or out of, the cavity.

7. A luminaire as claimed in any one of the preceding claims, in which the reflector comprises a shaped shell having a reflective sheet material laminated thereto to provide the reflective, suface(s) of the reflector.

8. A luminaire as claimed in claim 7, in which the shell is formed from an optically-transparent material, and the reflective sheet material is laminated to the outer surface thereof.

9. A luminaire as claimed in claim 7 or claim 8, in which the/each prismatic structure is an integral part of the shell.

10. A luminaire as claimed in claim 2, in which the prismatic structures engage, and serve to hold the reflector on, the elongate light source.

11. A luminaire as claimed in claim 2, in which the prismatic structures engage the elongate light source and thereby close the space between the rearward side of the light source and the inner surface of the reflector.

12. A luminaire as claimed in any one of claims 1 to 11, the luminaire providing a light output which, in a plane transverse to the direction of extent of the light source, is in the form of a narrow beam and has an intensity peak in the forwards direction.

13. A backlight system comprising a luminaire as claimed in claim 12, and a light guide arranged to receive light through one edge from the luminaire.

14. A luminaire as claimed in any one of claims 1 to 11, the luminaire providing a light output which, in a plane transverse to the direction of extent of the light source, is in the form of a diverging beam and has two intensity peaks, one on each side of the forwards direction.

15. A lighting system comprising a luminaire as claimed in claim 14, the luminaire being arranged to emit light generally downwards towards an area to be illuminated.

16. A luminaire substantially as described herein with reference to, and as illustrated by, FIGS. 1 to 3, or any one of FIGS. 4 to 7 of the accompanying drawings.
